(19) United States
(12) Patent Application Publication
(10) Pub. No.: US 2018/0157949 A1
(43) Pub. Date: Jun. 7, 2018

(54) MULTI-CHIP SMART CARD

(71) Applicant: TOUCHSTONE ID COP., Bellevue, WA (US)

(72) Inventors: Dietmar Wennemer, Kitchener (CA); Max Rahm, Kitchener (CA); Marc Meunier, Kitchener (CA); Vahid Moosavi, Kitchener (CA); Todd R. Paleczny, Kitchener (CA)

(73) Assignee: CENTER ID, Bellevue, WA (US)

(21) Appl. No.: 15/568,314

(22) PCT Filed: Apr. 22, 2016
(86) PCT No.: PCT/US16/28816

§ 371 Date: Oct. 20, 2017

Related U.S. Application Data
(60) Provisional application No. 62/151,251, filed on Apr. 22, 2015.
(60) Provisional application No. 62/152,480, filed on Apr. 24, 2015.
(60) Provisional application No. 62/152,491, filed on Apr. 24, 2015.
(60) Provisional application No. 62/152,504, filed on Apr. 24, 2015.

(51) Int. Cl. G06K 19/07; G06Q 20/34; G06K 19/06

(52) U.S. Cl. CPC G06K 19/0725; G06F 21/34; G06K 19/06206; G06Q 20/341

(57) ABSTRACT

Systems and methods are provided for a smart card to emulate chip cards and/or magnetic stripe cards. A smart card may attach to a device that programs the smart card to emulate the chip cards and/or the magnetic stripe cards. The base device may carry information regarding each card to be emulated, and may display a representation of such cards to be emulated on a touch display of the base device. A user may select a card to be emulated by interacting with the touch display. The smart card may include a contact area, a plurality of chips, and a switch to transmit signals between the contact area and a selected chip representing the card to be emulated.

### CROSS-REFERENCE TO RELATED APPLICATIONS

This application claims priority to PCT Application No. PCT/US16/28816, which claims the benefit of U.S. Provisional Application Nos. 62/151,251 filed Apr. 22, 2015, 62/152,480, filed Apr. 24, 2015, 62/152,491, filed Apr. 24, 2015, and 62/152,504, filed Apr. 24, 2015, the disclosures of which are incorporated herein by reference in their entirety.

### BACKGROUND

Smart cards, which are also known as chip cards and integrated circuit cards, are used for credit cards, debit cards, customer account cards, identification cards, loyalty cards, or the like. Smart cards may replace magnetic stripe cards, which are also known as magstripe cards or swipe cards. A smart card typically has a chip or security circuit, which may provide one or more features for ensuring security of transactions made using the smart card. In contrast, a magnetic stripe card typically has a band of magnetic material on the card in which a small amount of data may be encoded. A smart card may be a contactless smart card or a contact smart card. A contactless smart card wirelessly communicates with a card reader or terminal, for example, using radio frequency identification (RFID) technology such as Near Field Communication (NFC). A contact smart card communicates with a card reader or terminal via a contact pad or other physical connection.

A smart card or a magnetic stripe card is typically provisioned with information by a card provider. Because each card provider typically issues its own cards, a typical user must carry many cards from a variety of card providers. Accordingly, there is a need to improve systems and methods for reducing the number of cards that a user carries.

### SUMMARY

In accordance with embodiments of the present invention, a smart card is provided, comprising: at least one interface; a multiplexor component electrically coupled to at least one interface; a first security circuit electrically coupled to the multiplexor component, wherein the first security circuit is configured to transmit a first signal to the multiplexor component, wherein the first security circuit is configured to be provisioned with first information; and a second security circuit electrically coupled to the multiplexor component, wherein the second security circuit is configured to transmit a second signal to the multiplexor component, wherein the second security circuit is configured to be provisioned with second information, wherein the multiplexor component is configured to select a selected signal from at least one of the first signal and the second signal, wherein the multiplexor component is configured to transmit the selected signal to the at least one interface.

In accordance with embodiments of the present invention, a method is provided, comprising: provisioning a first security circuit with first information, wherein the first security circuit is configured to transmit a first signal; provisioning a second security circuit with second information, wherein the second security circuit is configured to transmit a second signal; providing a smart card with the first security circuit and the second security circuit, wherein the first security circuit is communicatively coupled to a multiplexor component of the smart card, wherein the second security circuit is communicatively coupled to the multiplexor component, wherein the multiplexor component is communicatively coupled to at least one interface of the smart card, wherein the multiplexor component is configured to select a selected signal from at least one of the first signal and the second signal, wherein the multiplexor component is configured to transmit the selected signal to the at least one interface.

### BRIEF DESCRIPTION OF DRAWINGS

FIGS. 1A-1D illustrate perspective views of an example card system, in accordance with embodiments of the present disclosure.

FIGS. 2A-2E illustrate an example card, in accordance with embodiments of the present disclosure.

FIGS. 3A-3B illustrate an example card system, in accordance with embodiments of the present disclosure.

FIGS. 4A-4B illustrate an example device connector module, in accordance with embodiments of the present disclosure.

FIG. 5 is a flowchart illustrating a method of disabling a card, in accordance with embodiments of the present disclosure.

FIG. 6 is a block diagram illustrating an example card, in accordance with embodiments of the present disclosure.

FIG. 7 is a flowchart illustrating a method of assembling a card with a plurality of chips, in accordance with embodiments of the present disclosure.

FIG. 8 is a block diagram illustrating an example card, in accordance with embodiments of the present disclosure.

FIG. 9 is a block diagram illustrating an example card system, in accordance with embodiments of the present disclosure.

FIG. 10 is a flowchart illustrating a method of assembling a card with a plurality of chips, in accordance with embodiments of the present disclosure.

FIG. 11 is a block diagram of NFC device in a smart card, in accordance with embodiments of the present disclosure.

FIG. 12 is a block diagram of an NFC transmitter that is configured to communicate with the NFC device shown in FIG. 11, in accordance with embodiments of the present disclosure.

### DETAILED DESCRIPTION

In the following description, reference is made to the accompanying drawings that illustrate several embodiments of the present disclosure. It is understood that other embodiments may be utilized and mechanical, compositional, structural, electrical, or operational changes may be made without departing from the spirit and scope of the present disclosure. The following detailed description is not to be taken in a limiting sense, and the scope of the embodiments of the present disclosure is defined only by the claims of the issued patent.

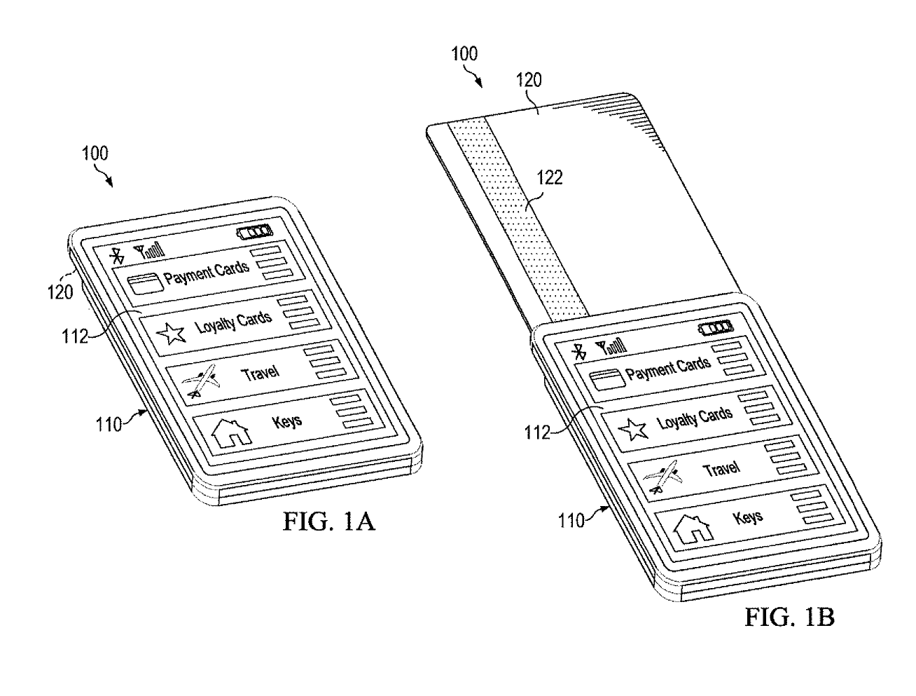

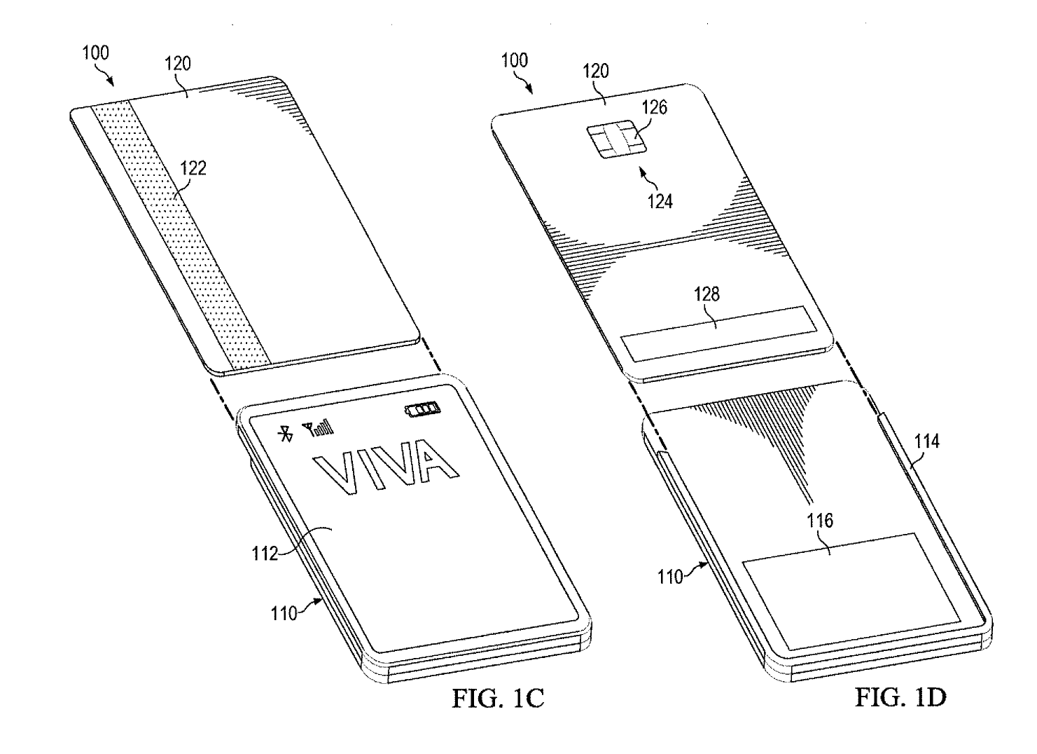

FIGS. 1A-1D illustrate perspective views of an example card system 100, in accordance with embodiments of the present disclosure. As illustrated in FIG. 1A, a base device 110 may be a card holder, a card carrier, a card wallet, or the like. The base device 110 may have a touch display 112, which may be an electrophorescent display, a liquid crystal display (LCD), or the like. The touch display 112 may have a touch component that may, for example, receive user inputs based on touches from a user's finger. It is to be understood that in alternative embodiments, the base device 110 may have a display with a separate user input component, such as user buttons or the like. It is to be further understood that the touch component of the touch display 112 may receive input in ways other than a user touch, such as tracking a user's eye movement or the like.

Although not visible in the perspective view of FIG. 1A, the base device 110 may hold a smart card 120. The smart card 120 may be configurable to emulate a variety of individual cards such as smart cards, magnetic stripe cards, or the like. The touch display 112 may display choices of types of individual cards, such as payment cards, loyalty cards, travel cards, key cards, or the like. A payment card may be issued by a bank, a financial services provider, or the like. A loyalty card may be issued by a business such as a clothing store, a grocery store, or the like. A travel card may be issued by an airline, a car rental company, or the like. A key card may be issued by a security company, a hotel, a car rental company, an automobile manufacturer, or the like to provide access to a building, a vehicle, or the like.

Under some embodiments, the display 112 may display representations of individual cards grouped based on types of cards. For example, if a user holds a Visa credit or debit card from Visa, Inc. and an American Express card from American Express Company, representations of both such cards may be grouped under the payment card type. As illustrated in FIG. 1A, virtual buttons may be displayed on the right side of the display 112. A virtual button may represent an individual card or may represent a sub-group of individual cards. Actuation of the virtual button representing an individual card (e.g, by a user touching a touch-sensitive screen depicting the virtual button) may cause selection of the individual card, and actuation of the virtual button representing a sub-group of individual cards may cause display of those individual cards or another virtual button representing a second sub-group of individual cards. The sub-groups can be organized in any desired way, such as, for example, by category of card (e.g., payment cards, loyalty cards, travel, and keys), or as configured by the user. Selection of an individual card may cause the smart card 120 to be configured by the base device 110 to emulate the selected individual card. It is to be understood that the types of cards illustrated in FIG. 1A are for illustrative purposes, and are not meant to be limiting.

The touch display 112 illustrated in FIG. 1A may display an indication of a computing device interface with a computing device such as a personal computer, a tablet computer, a smart phone, or the like. For example, the interface may be a short-range communications interface, e.g., an interface compliant with the Bluetooth standard, a local area network wireless interface, e.g., an interface compliant with the WiFi standard, or an interface utilizing a different communication standard or protocol. Under some embodiments, the information used to deploy, program, or implement the smart card 120 to emulate an individual card may be received via the computing device interface. After the information is loaded onto the base device 110, the smart card 120 may be deployed, programmed, or implemented with such information such that the smart card 120 may be reused repeatedly by selectively emulating different individual cards. The touch display 112 may also display an indication of battery power remaining for the base device 110. It is to be understood that to conserve battery power, the base device 110 may be in an off state, and may be switched on by swiping the touch display 112, by coupling or decoupling the smart card 120 to the base device 110 and/or via a snap switch or the like that activates the base device 110 by flicking the finger against the base device 110 or tapping the base device 110 against a hard surface.

As illustrated in FIG. 1B, after the smart card 120 has been configured to emulate an individual card, the smart card 120 may be decoupled, detached, or removed from the base device 110. Under some embodiments, the base device 110 may include information about an individual card that facilitates the configuration of the smart card 120 to emulate the individual card for the purposes of conducting a transaction. For example, an individual card may be a credit card, and the information about the credit card may be the credit card number. Under this embodiment, the credit card number may be communicated from the base device 110 to the smart card 120, and a magnetic stripe module 122 or first communication interface of the smart card 120 may be configured to emulate the individual card's representation of the credit card number. Under this embodiment, the smart card 120 may be swiped in a card reader instead of the individual card. Although not shown in FIG. 1B, the smart card 120 may also be configured to emulate a smart card that is a credit card having a credit card number. The base device 110 may allow the user to select via the touch display 112 which individual card is to be emulated by the smart card 120.

FIG. 1B illustrates the smart card 120 having the magnetic stripe module 122 that may emulate a magnetic stripe of a selected individual magnetic stripe card. For example, as illustrated in FIG. 1C, a user may have selected a hypothetical Viva-brand credit or debit card, and the Viva logo may appear on the display 112 of the base device 110. The base device 110 may have caused the magnetic stripe module 122 to emulate a magnetic stripe of the user's Viva credit or debit card. Accordingly, the smart card 120 may be swiped at a card reader, or may otherwise communicatively couple with the card reader.

As illustrated in FIG. 1D, a card may have a chip module 124 or second communication interface that may comprise a contact area 126 that is communicatively coupled to at least one chip of the smart card 120, and the chip of the smart card 120 may be configured to emulate a chip of the selected individual card. Under some embodiments, the chip may be embedded within the smart card 120. The chip may be communicatively coupled to at least one contact to foiiu the chip module 124 or a chip interface. Accordingly, the smart card 120 may be inserted into and read by a card reader, or may otherwise communicatively couple with the card reader. Although not shown in FIGS. 1A-D, the system 100 may include a near field communication (NFC) interface, or a third communication interface, with which the smart card 120 and/or the base device 110 may wirelessly communicate with the card reader. Accordingly, after a user selects an individual card from the touch display 112, the information about the individual card may be deployed on the smart card 120 for use with a magnetic stripe interface, a chip interface, an NFC interface, and/or the like.

It is to be understood that FIG. 1D illustrates the base device 110 and the smart card 120 in a different orientation than the orientation illustrated in FIG. 1C. The front of the base device 110 is illustrated in FIG. 1C having an orientation with the display 112 visible. In contrast, the back of the base device 110 is illustrated in FIG. 1D having an orientation showing a coupling component 114, which can be, e.g., a band, a sleeve, an arm, a slider, or the like. The coupling component 114 may removably couple, hold, or secure the smart card 120 to the base device 110. For example, the coupling component 114 in the embodiment of FIG. 1D illustrates a rim 114 that facilitates the smart card 120 sliding in and out of position with respect to the base device 110, or otherwise coupling and decoupling to the base device 110. FIG. 1D also illustrates a device connector module 116 of the base device 110 that may communicatively couple with a card connector module 128 of the smart card 120 to facilitate communication between the base device 110 and the smart card 120. The back of the smart card 120 is illustrated in FIG. 1C having an orientation with the magnetic stripe module 122 visible. In contrast, the front of the smart card 120 is illustrated in FIG. 1D having an orientation with the contact area 126 and the card connector module 128 visible. It is to be understood that the smart card 120 may comprise one or more communication interfaces with a card reader such as the magnetic stripe module 122, the chip module 124, and/or an NFC interface. Furthermore, although FIG. 1C and FIG. 1D illustrate the magnetic stripe module 122 and the contact area 126 on opposite sides of the smart card 120, such may alternatively be on the same side of the smart card 120. It is to be understood that the side of the card on which the card connector module 128 is located is not meant to be limiting. For example, the card connector module 128 may be located on the same side as the chip module 124 as illustrated in FIG. 1D, or may be on the same side as the magnetic stripe module 122.

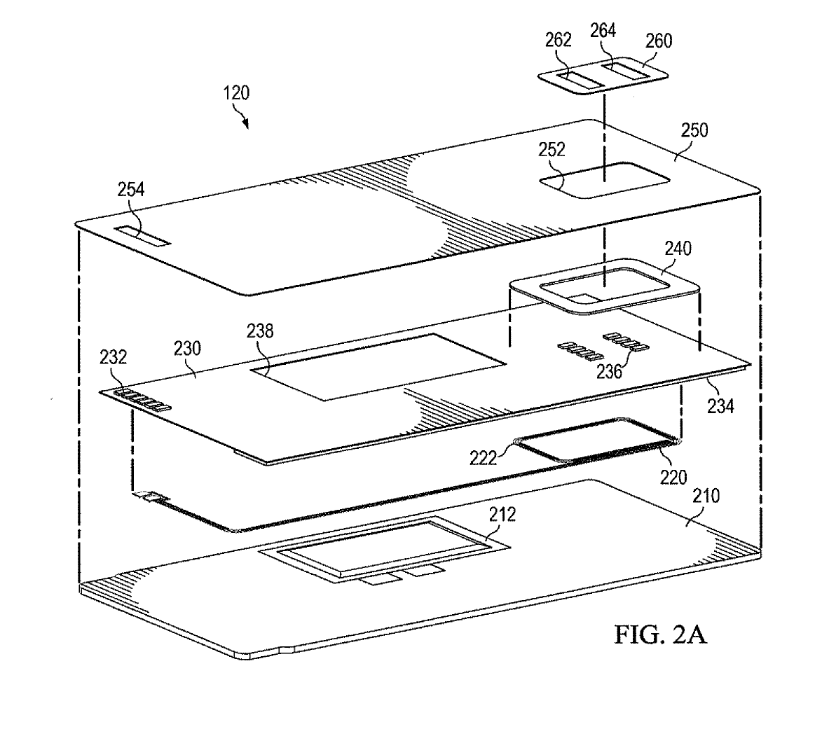

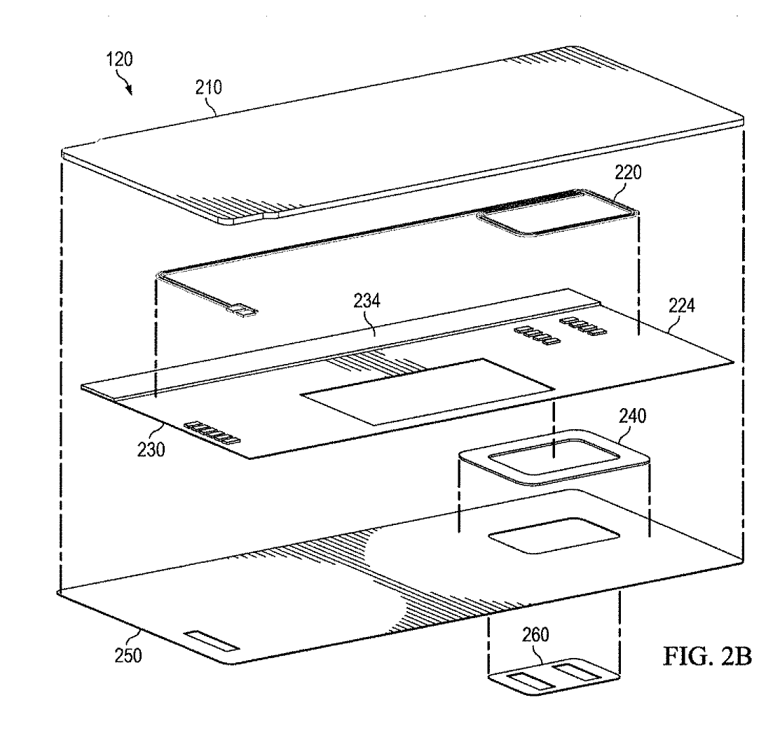

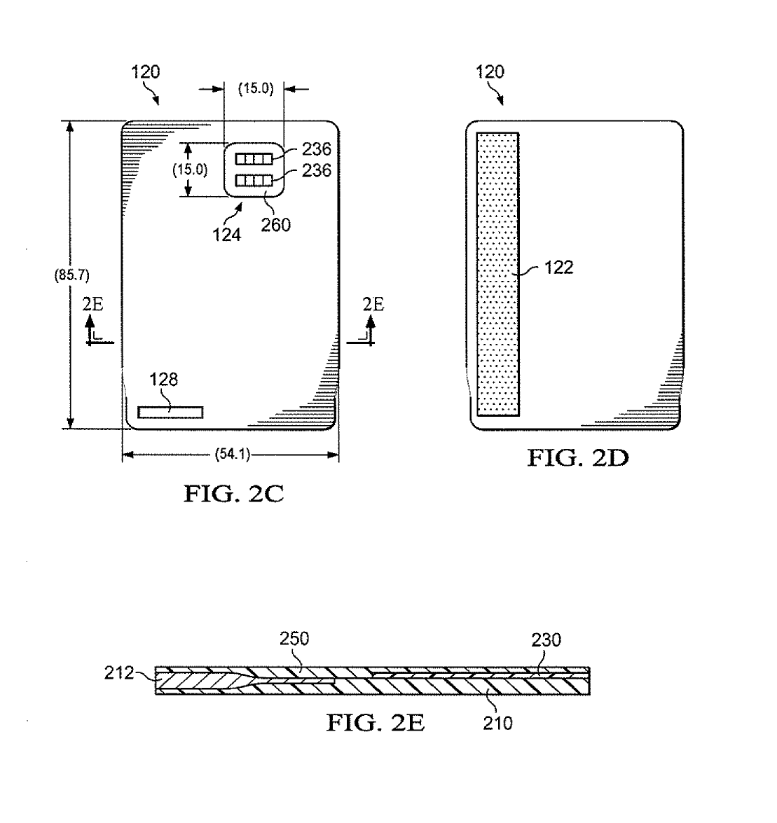

FIGS. 2A-2E illustrate an example smart card 120, in accordance with embodiments of the present disclosure. FIG. 2A illustrates an exploded perspective view of the smart card 120. As illustrated in FIG. 2A, the smart card 120 may have a back layer or back sheet 210. The back layer 210 may comprise a plastic material such as polyvinyl chloride (PVC) or acrylonitrile butadiene styrene (ABS), a metal alloy material, or the like. Under some embodiments, the back layer 210 may be a lamination layer that is laminated to other layers or components of the smart card 120. An optional battery 212 may be adhered to the back layer 210. In some embodiments, the battery 212 supplies power to some or all of the electronic components of the smart card 120. For example, the battery 212 may supply power to the magnetic stripe module 122 to facilitate emulation of an individual card's magnetic stripe. Under some embodiments, the battery 212 may receive a charge when the card is docked or coupled with the base device 110. Under such embodiments, the smart card 120 may be powered off or put in sleep mode to conserve battery power while the smart card 120 is coupled to the base device 110, and may be powered on or put in awake mode after a user makes a selection on the touch display 112 of the base device 110. It is to be understood that power may be supplied, in addition to a battery or in place of a battery, by a card reader or terminal, such as when the card reader electrically couples to the smart card 120 via the contact area 126. The battery 212 may be recharged using any desired recharging technologies, such as, for example, wireless recharging by a wireless charging circuit provided in the base device 110 or separate charging device.

The smart card 120 may have an optional antenna 220 and radio module 224 for providing the card 120 with wireless communications capability (e.g., an NFC antenna, a Bluetooth antenna, a Wi-Fi antenna, or the like). The antenna 220 may comprise an antenna coil 222, which may be loops of wire or the like. The radio module 224 may be communicatively coupled to a chip of the smart card 120. Under some embodiments, a reader may provide power to the chip via the antenna 220 utilizing resonant inductive coupling, electrodynamic induction, or the like.

The smart card 120 may include a printed circuit board (PCB) 230. The PCB 230 may include one or more electronic components of the smart card 120, including a processor, and may provide electrical connections between such components. The PCB 230 may also have an aperture 238 within which the battery 212 may be positioned, in order to decrease the overall thickness of the smart card 120. The card connector module 128 may comprise at least one device interface contact 232, such as two to eight device interface contacts 232 or six device interface contacts 232 as illustrated in FIG. 2A. The PCB 230 may include such device interface contacts 232 that are configured to electrically couple with one or more contacts of the base device 110, such as at the device connector module 116 of the base device 110.

The base device 110 may communicatively couple and/or supply power to the smart card 120 via the device interface contacts 232. The magnetic stripe module 122 may comprise a magnetic stripe emulator 234, which may be included with the PCB 230. The PCB 230 may also comprise at least one chip, or security circuit, communicatively coupled to one or more reader interface contacts 236. Under some embodiments, the PCB 230 may carry a security circuit, such as a payment chip in compliance with the Europay, MasterCard and Visa (EMV) standard. In other embodiments, the security circuit may comprise a secure element (SE) which is a tamper-resistant platform in which application code and application data can be securely stored and administered, and in which secure execution of applications occur.

The smart card 120 may have a magnetic sheet 240, such as a ferrite sheet. The magnetic sheet 240 may have high magnetic permeability, which may enhance the performance of the antenna 220. The magnetic sheet 240 may be located at a surface of the PCB 230 that is opposite a surface where the antenna coil 222 is located. The magnetic sheet 240 may have length and width dimensions that are comparable to the length and width dimensions of the antenna coil 222.

The smart card 120 may have a front layer or front sheet 250 opposite the back layer 210. The front layer 250 may comprise a plastic material or a metal alloy material such as stainless steel or the like. The front layer 250 may have length and width dimensions that are equivalent or comparable to the length and width dimensions of the back layer 210. Furthermore, the PCB 230 may have length and width dimensions that are equivalent or less than the length and width dimensions of the front layer 250 and/or the back layer 210. Such dimensions may sandwich the PCB 230 between the front layer 250 and the back layer 210 to form the smart card 120. The front layer 250 may have a first aperture 252 to provide access to the reader interface contacts 236, and may have a second aperture 254 to provide access to the device interface contacts 232. An optional contact area cover 260 may be placed within the first aperture 252, and the contact area cover 260 may have a first aperture 262 and a second aperture 264 to provide access to the reader interface contacts 236. The contact area cover 260 may be comprised of a plastic material, and may advantageously provide insulation or cosmetic improvements to the chip module 124.

FIG. 2B illustrates an exploded perspective view of the smart card 120 from a different orientation than the orientation of the smart card 120 of FIG. 2A. As illustrated in FIG. 2B, the back layer 210 is opposite the front layer 250, and in between the back layer 210 and the front layer 250 are, for example, the antenna 220 and the PCB 230. The orientation of FIG. 2B also illustrates a view of the magnetic stripe emulator 234, which is not visible in FIG. 2A. The PCB may include the radio module 224 such as an NFC circuit or the like, which may facilitate radio communication between the smart card 120 and a card reader via the antenna 220.

FIG. 2C illustrates a front view of the smart card 120 having example dimensions in millimeters (mm). It is to be understood that the dimensions are for illustrative purposes and are not to be considered limiting. As illustrated in FIG. 2C, the smart card 120 may have a length of about 85.7 mm and a width of about 54.1 mm. The smart card 120 may include the card connector module 128. The smart card 120 may also include a chip module 124 having a contact area cover 260 and at least one reader interface contact 236. The contact area cover 260 may have a length of about 15 mm and a width of about 15 mm.

FIG. 2D illustrates a back view of the smart card 120. As illustrated in FIG. 2D, the smart card 120 may include the magnetic stripe module 122. FIG. 2E illustrates a cross-sectional view of a smart card 120 at line 2E-2E of the embodiment of FIG. 2C. As illustrated in FIG. 2E, the smart card 120 may include the back layer 210, the battery 212, the PCB 230, and the front layer 250.

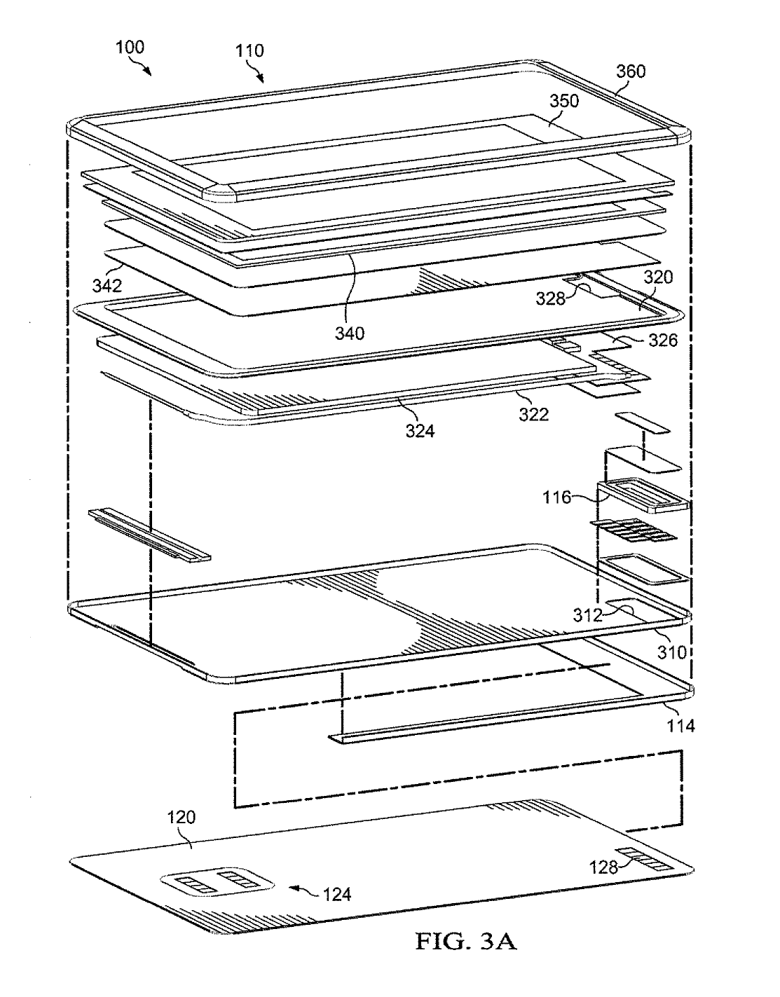

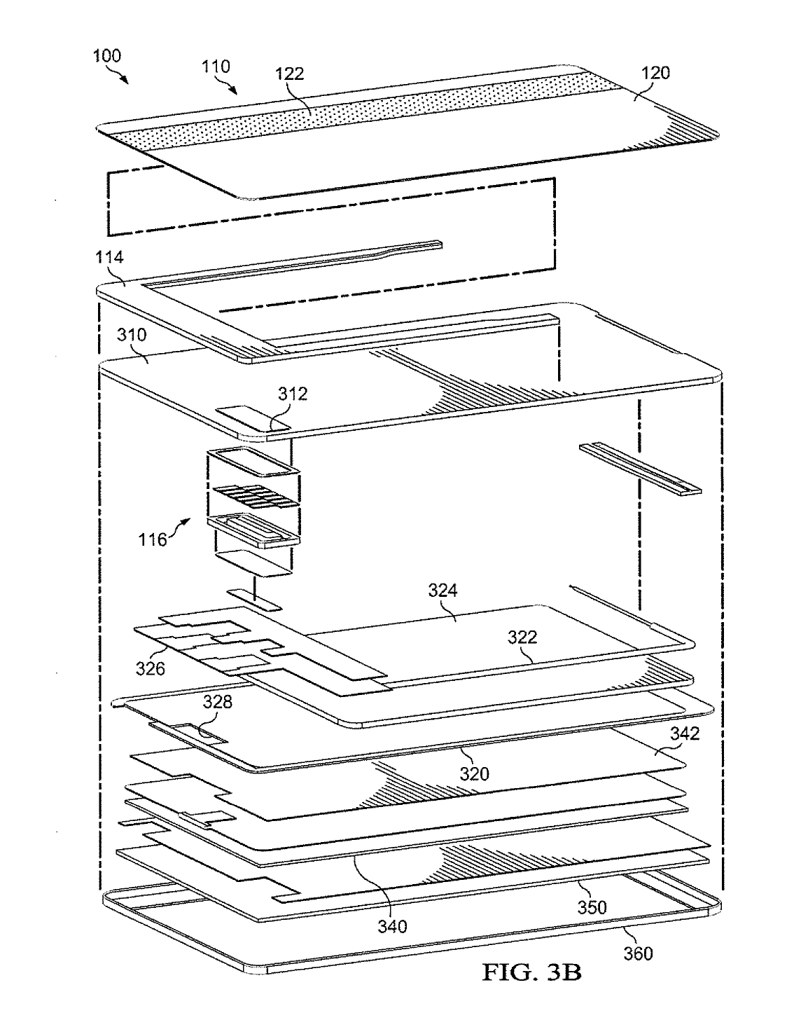

FIGS. 3A-3B illustrate an example card system 100, in accordance with embodiments of the present disclosure. FIG. 3A illustrates a smart card 120 and an exploded perspective view of a base device 110. The smart card 120 may include the card connector module 128 and the chip module 124. The base device 110 includes a back chassis 310 and the coupling component 114. Under this embodiment, the smart card 120 may be removably inserted between the back chassis 310 and a portion of the coupling component 114. It is to be understood that the coupling component 114 may couple, attach, or fasten the smart card 120 to the base device 110. The back chassis may have an aperture 312 that may expose the device connector module 116 that may electrically couple to the card connector module 128 when the smart card 120 is coupled to the base device 110. The device connector module 116 may be coupled to a PCB 326, which may be coupled to an inner chassis 320. A battery 324 may be electrically coupled to the PCB 326, and may provide power to electronic components that are electrically coupled to the PCB 326. For example, the base device 110 may include a radio module for short range RF communications that is coupled to the PCB 326, and an antenna 322 coupled to the radio module. The radio module may be powered by the battery 324. Like battery 212, the base device battery 324 may be recharged using any desired recharging technologies. For example, the base device 110 may include a power port which may be coupled to a standard AC power receptacle using a charging cable. Alternatively, the base device 110 may be configured for wireless recharging by a wireless charging circuit provided in a separate device, such as a base station plugged into a standard AC power receptacle.

It is to be understood that the PCB 326 may include a processor for executing instructions, retrieving data stored in a storage element or memory, or deploying the smart card 120 to emulate an individual card. The storage element can include one or more different types of memory, data storage or computer-readable storage media, such as, for example, a first data storage for program instructions for execution by the processor, and a second data storage for images or data. The storage element may store software for execution by the processor, such as, for example, operating system software and applications, such as an application for a user to select an individual card as illustrated in FIGS. 1A-1D. The storage element may also store a data item, such as, for example, card information or a card file corresponding to the individual card.

The inner chassis 320 may have an aperture 328 through which the PCB 326 may be communicatively coupled to components of the base device 110 that are located on a side of the inner chassis 320 that is opposed to the side of the inner chassis 320 where the PCB 326 is located. For example, the touch display 112 may be coupled to a side of the inner chassis 320 with a pressure sensitive adhesive (PSA) 342, and the touch display 112 may be coupled to the PCB 326 via a flexible printed circuit (FPC) or the like. The touch display 112 may include a display component 340 such as an e-ink display, an LCD, or the like. The touch display 112 may also include a touch panel 350 that enables touch-enabled or gesture-controlled functionality, so as to detect movement of a finger across the surface of the touch display 112 and to interpret such detections as user inputs. The base device 110 may include a bezel 360 or upper band that couples to the back chassis 310 and/or the inner chassis 320 to form the base device 110. Under some embodiments, the bezel 360, the inner chassis 320, and the back chassis 310 may comprise a material of metal alloy such as stainless steel.

FIG. 3B illustrates a smart card 120 and an exploded perspective view of a base device 110 in a different orientation than the orientation illustrated in FIG. 3A. For example, the smart card 120 is oriented to show the magnetic stripe module 122, which is not visible in FIG. 3A.

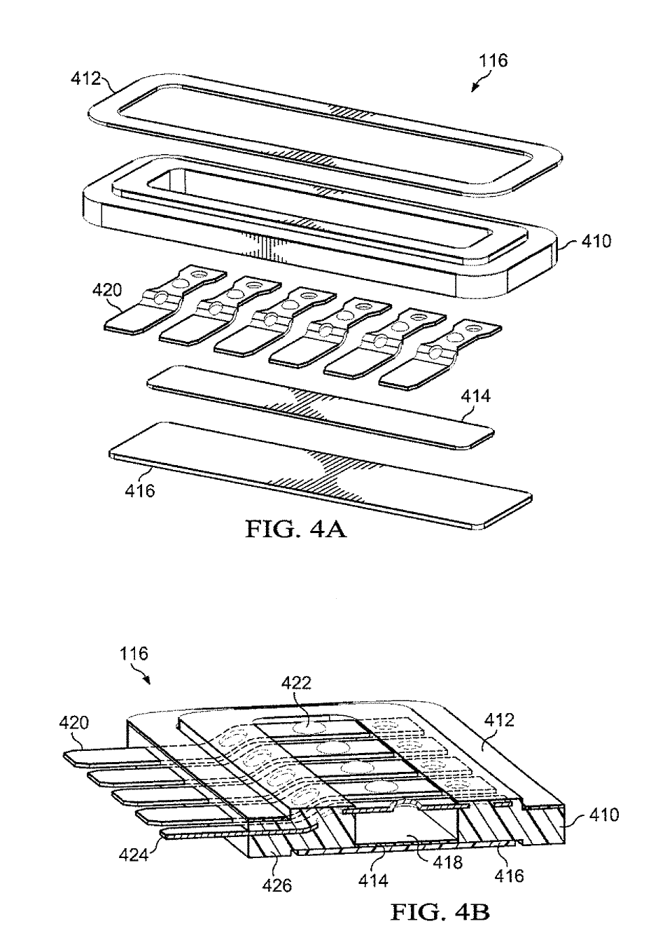

FIGS. 4A-4B illustrate an example device connector module 116, in accordance with embodiments of the present disclosure. FIG. 4A illustrates an exploded perspective view of a device connector module 116. The device connector module 116 may include a frame 410 that may be molded from polycarbonate material or the like. The device connector module 116 may include a first PSA 412 that may be die cut and may couple or adhere the frame 410 to the inner chassis 320. The device connector module 116 may include one or more spring contacts 420 coupled to the frame, for example by over molding the frame 410 around the contacts 420. There may be, for example, an array of six spring contacts 420 or two to eight spring contacts 420, and each spring contact 420 may comprise a beryllium copper material or the like. The device connector module 116 may include a coverlay 414 or coverfilm that may be die cut from a non-adhesive and low friction material, and which may increase ingress protection of the device connector module 116 or may prevent debris buildup. The device connector module 116 may include a second PSA 416 that may be die cut and may seal the bottom of the frame 410.

FIG. 4B illustrates a cross-sectional perspective view of a device connector module 116. FIG. 4B illustrates a contamination well 418 of the device connector module. FIG. 4B also illustrates an example configuration of an array of contacts 420. The contact 420 may include a contact protrusion 422 to improve communicatively coupling the base device 110 to the smart card 120. Under some embodiments, the contact protrusion 422 may allow for mechanically tuned deflection and may improve the electrical contact with the card connector module 128. The contact 420 may include one or more holes 426 to improve the mechanical locking to the frame 410. The contact 420 may include a contact tab 424 through which electrical signals can pass, for example, to the PCB 326. Under some embodiments, the contact tab 424 may be coupled to the PCB 326 with laser soldering or the like.

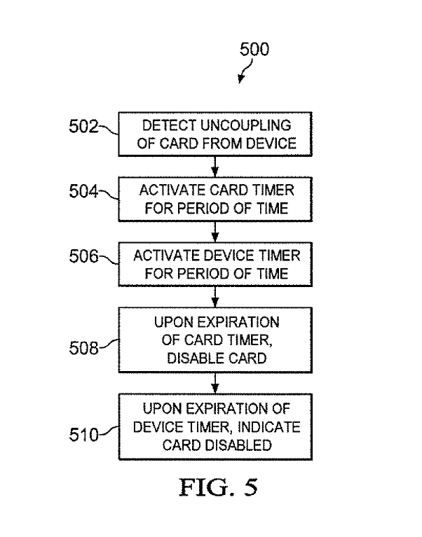

FIG. 5 is a flowchart illustrating a method 500 of disabling a card, in accordance with embodiments of the present disclosure. At step 502, the smart card 120 may be uncoupled or detached from the base device 110. Under some embodiments, prior to the uncoupling at step 502, the smart card 120 may have been deployed with information of an individual card. For example, if the individual card includes a security circuit in compliance with the EMV standard (e.g., an “EMV chip”), then a chip of the smart card 120 may be deployed with the same or similar information as the individual card's EMV chip. Under this example, the chip of the smart card 120 may also be communicatively coupled with the reader interface contacts 236. For further example, if the individual card comprised a magnetic stripe, then information related to the individual card's magnetic stripe may be stored in a memory of the PCB 230 or a memory of the magnetic stripe emulator 234. Such memory may, for example, be flash memory of a processor of the PCB 230 or may be field-programmable gate array (FPGA) memory of the magnetic stripe emulator 234.

At step 504, upon the detection at step 502 that the smart card 120 has been uncoupled from the base device 110, a timer or clock of the smart card 120 may be activated for a period of time such as one minute, two minutes, or another period of time defined by a user. The card timer, for example, may be activated by a processor coupled to the PCB 230. At step 506, upon the detection at step 502 that the smart card 120 has been uncoupled from the base device 110, a timer or clock of the base device 110 may be activated for the same period of time as at step 504. The device timer, for example, may be activated by a processor coupled to the PCB 326. It is to be understood that under this embodiment, because the card timer and the device timer are activated at a similar point of time based on the same detection of uncoupling at step 502, and because both the card timer and the device timer are set for the same or similar period of time, then the card timer and the device timer may both expire at about the same or similar point of time, even though they are uncoupled from each other.

At step 508, upon expiration of the card timer, the smart card 120 may be disabled. For example, if the smart card 120 is deployed with information stored on a memory of a chip, then the chip may be communicatively interrupted or decoupled from the reader interface contacts 236. Furthermore, if the chip contains information stored in memory that is insecure, such information may be deleted or erased from the insecure memory of the chip. For further example, if the smart card 120 is deployed to emulate a magnetic stripe, the information stored in memory of the smart card 120 or of the magnetic stripe emulator 234 may be deleted, erased, or the like. While such examples of disablement of the card are not meant to be limiting, such disablement of the smart card 120 may be advantageous to conserve power or battery life of the smart card 120 or to increase security measures of the smart card 120 by deleting insecure information or making such information inaccessible through the reader communication interfaces of the smart card 120. Such security measures may be beneficial if the smart card 120 was misplaced by a user.

At step 510, upon expiration of the device timer, the base device 110 may indicate that the card has been disabled. For example, the touch display 112 may be turned off or go blank. In some embodiments, while the smart card 120 is active, a message may be displayed by the display 112 that the smart card 120 is active and information about the card may be displayed, such as the word Viva displayed in FIG. 1C. In some embodiments, prior to the display 112 going blank, a message may be displayed by the display 112 that the smart card 120 has been disabled or is about to be disabled, depending on the expiration state of the device timer. Under other embodiments, a light may flash on the base device 110 to indicate that the smart card 120 has been disabled or is no longer functioning. While such examples of a device indication of card disablement are not meant to be limiting, such indication of the disablement of the smart card 120 may be advantageous because it may not otherwise be apparent to a user that the smart card 120 has been disabled. For example, when the smart card 120 does not have a user interface, such as an indicator light, the user may not realize that information from the smart card 120 has been deleted or that emulation functionality of the smart card 120 has been interrupted. The lack of a user interface of the smart card 120 may be beneficial to conserve battery power, and the indication of the base device 110 may be useful to inform the user that the card has been disabled.

Under some embodiments, after the smart card 120 has been disabled, it may be re-enabled by coupling or reattaching the smart card 120 to the base device 110. Such re-enablement may comprise, for example, redeploying the smart card 120 with the information that was deleted, or deploying the smart card 120 with new information, such as to emulate a different individual card.

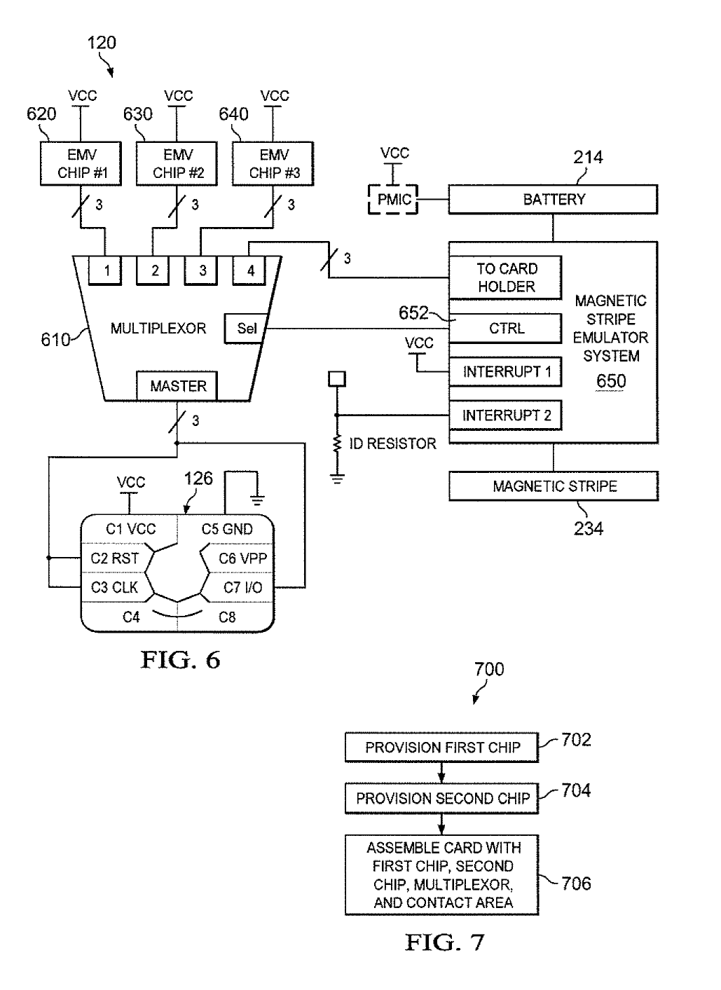

FIG. 6 is a block diagram illustrating a smart card 120, in accordance with embodiments of the present disclosure. The smart card 120 may have a contact area 126 comprising a contact pad with eight reader interface contacts labeled C1-C8. C1 may be designated VCC for a power supply input through which operating power may be supplied to a chip of the smart card 120. C2 may be designated RST for receiving a reset signal to cause a chip of the smart card 120 to initiate a reset sequence of instructions. C3 may be designated CLK for receiving a clock signal to control the clock speed of a chip of the smart card 120. C4 may be a first auxiliary contact. C5 may be designated GND for providing a ground line between a card reader and the smart card 120. C6 may be designated VPP for receiving a programming voltage to program memory of a chip of the smart card 120. C7 may be designated for receiving an input/output signal, for example, for serial input and output between a card reader and a chip of the smart card 120. C8 may be a second auxiliary contact.

As illustrated in FIG. 6, three lines may communicatively couple the reader interface contacts labeled C2, C3, and C7 with a multiplexor component 610 or switch. For purposes of simplicity, the three lines may be combined into a single channel labeled “/3.” The multiplexor component 610 may include a master channel that is coupled to the contact area 126. The multiplexor component 610 may also include four channels that are respectively coupled to a first chip 620, a second chip 630, a third chip 640, and a magnetic stripe emulator system 650. It is to be understood that the number of channels, chips, and emulator systems is not meant to be limiting.

Under the embodiment of FIG. 6, the chips 620, 630, 640 may each be provisioned by a chip provisioner entity, such as a bank, a credit card company, or other entity. For example, the first chip 620 may be provisioned for a Visa credit or debit card, the second chip 630 may be provisioned for MasterCard credit or debit card, and the third chip 640 may be provisioned for an American Express credit card. Provisioning of a chip may include installing an application or applet on each chip, where the applet is specific to the chip provisioner. Provisioning of the chip may include personalization of the chip, for example, storing personal data of a user on the chip, such as the user's credit card number. It is to be understood that various entities may provision different chips and/or may perform different sub-processes of a provisioning process. For example, a credit card company may provision a chip with an applet, and a bank may personalize the chip with a user's information. Furthermore, the provisioning of a chip may be performed after it is assembled into the smart card 120.

Under the embodiment of FIG. 6, a user may select one of the first chip 620, the second chip 630, the third chip 640, and the magnetic stripe emulator system 650. Based on the selection, the signals to or from the selected chip or system may be transmitted by the multiplexor component 610 via the master channel to or from the contact area 126. The selection may be performed by a user interacting with the touch display 112 of the base device 110, as illustrated in FIGS. 1A-1C. Alternatively, the selection may be performed by a user interacting with a user interface of a separate computing device, such as a smartphone, that is, for example, in wireless communication with the smart card 120. Such a user interface of the computing device may be similar to the user interface illustrated in FIGS. 1A-1C. Alternatively, or in addition, the smart card 120 may have a user interface, such as at least one button that upon activation indicates a user's selection of a chip.

As illustrated in FIG. 6, the smart card 120 may include the battery 214 that may power the magnetic stripe emulator system 650 and the magnetic stripe emulator 234. Under this embodiment, the information related to an individual magnetic stripe card may be transmitted via a fourth channel to the multiplexor, and when the magnetic stripe card is selected, the information related to the magnetic stripe may be transmitted to or from the contact area 126 by the multiplexor component 610 via the master channel. The magnetic stripe emulator system 650 may also have a control (CTRL) module 652 that electronically couples with a selection (SEL) module 612 of the multiplexor component 610 to indicate which chip or system has been selected by the user. Under some embodiments, a microprocessor of the smart card 120 may comprise the control module 652.

The use of the multiplexor component 610 of the smart card 120 may be advantageous because it allows for more than one chip to be provided on the smart card 120. Such may be beneficial when a chip provisioner wishes to limit the storage of information on the chip to information that is relevant only to the chip provisioner. For example, a chip provisioner may prefer that only its own applet be installed on a chip. The multiplexor component 610 illustrated in FIG. 6 allows for each chip provisioner to have its own dedicated chip on the smart card 120, while also allowing for a plurality of such chips to be included on a single smart card 120. The chip provisioner may prefer that its chips be independent from other chip provisioners due to security concerns or due to storage limitations of the chip.

FIG. 7 is a flowchart 700 illustrating a method of assembling a smart card 120 with a first chip 620 and a second chip 630, in accordance with embodiments of the present disclosure. At step 702, a first chip may be provisioned by a first chip provisioner, such as a first entity or bank. At step 704, a second chip may be provisioned by a second chip provisioner, such as a second entity or bank. At step 706, a smart card 120 may be assembled with the first chip 620, the second chip 630, and the multiplexor component 610, which may be electrically coupled to the first chip 620 via a first channel and may be electrically coupled to the second chip 630 via a second channel. The smart card 120 may also be assembled with a contact area 126 that may be electrically coupled to the multiplexor component 610 via a main channel.

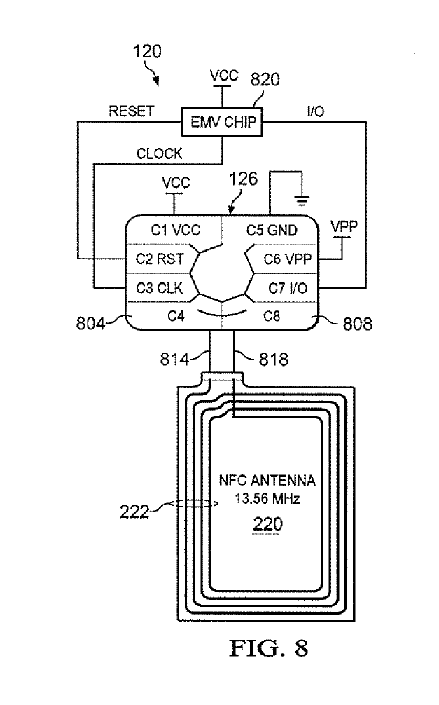

FIG. 8 is a block diagram illustrating a smart card 120, in accordance with embodiments of the present disclosure. The smart card 120 may have a contact area 126 comprising a contact pad with eight reader interface contacts labeled C1-C8, and C4 may be a first auxiliary contact 804 and C8 may be a second auxiliary contact 808. The first auxiliary contact 804 and the second auxiliary contact 808 may be electrically coupled to the antenna 220 via a first line 814 and a second line 818, respectively. The antenna 220 may include the antenna coil 222. Under some embodiments, the antenna 220 may be a loop inductor antenna or the like. The contact area 126 may comprise eight reader interface contacts, and while two of the reader interface contacts labeled C4 and C8 may be electrically coupled to the antenna 220, the remaining reader interface contacts labeled C1-C3 and C5-C7 may be utilized in relation to the chip 820. For example, the chip 820 may be electrically coupled to the contact area via a reset line, a clock line, and an input/output line.

As depicted in FIG. 8, the antenna 220 may be coupled to the first auxiliary contact 804 and to the second auxiliary contact 808, which may be advantageous because under some embodiments where the chip 820 is an EMV chip, the auxiliary contacts 804, 808 are not utilized for other purposes. However, it is to be understood that in some embodiments, any pair of reader interface contacts of the contact area 126 may be electrically coupled to the antenna 220 instead of or in addition to the reader interface contacts 804, 808. Furthermore, it is to be understood that the antenna 220 of FIG. 8 differs from the antenna 220 depicted in FIG. 2 in that the antenna 220 depicted in FIG. 2 may electrically couple to two or more device interface contacts 232, as opposed to two or more reader interface contacts of the contact area 126 depicted in FIG. 8. Electrically coupling the device to the contact area 126 as depicted in FIG. 8 may be advantageous to reduce the need for the smart card 120 to have dedicated device interface contacts 232 for the antenna 220, as depicted in FIG. 2, because the base device 110 may utilize the reader interface contacts instead.

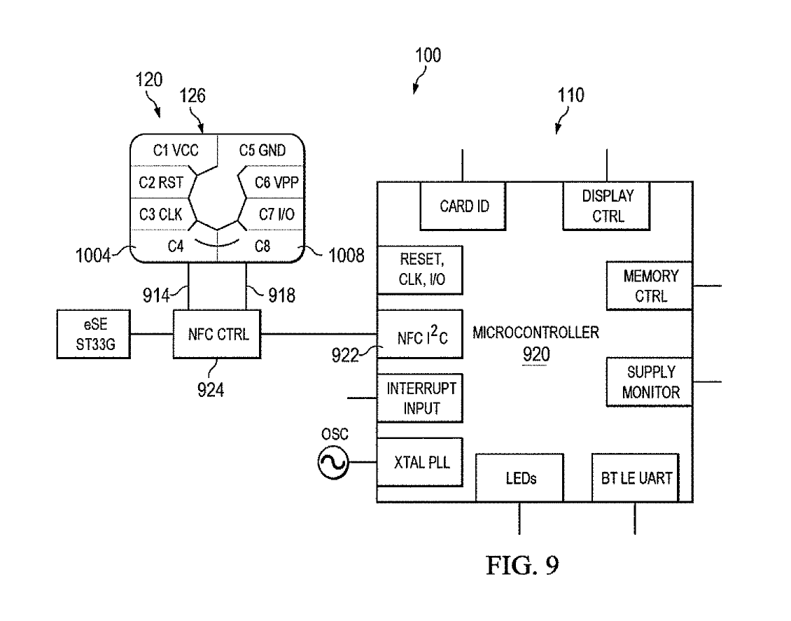

FIG. 9 is a block diagram illustrating an example card system 100, in accordance with embodiments of the present disclosure. FIG. 9 illustrates the contact area 126 of the smart card 120. The contact area 126 includes the first auxiliary contact 804 and the second auxiliary contact 808, which is similar to the contact area 126 illustrated in FIG. 8. The base device 110 may include a first antenna contact 914 that may removably couple to the first auxiliary contact 804 of the smart card 120. The base device 110 may also include a second antenna contact 918 that may removably couple to the second auxiliary contact 808 of the smart card 120. The first antenna contact 914 and the second antenna contact 918 may be coupled to an antenna controller module 924, such as an NFC controller, which may be coupled to an antenna interface module 922, such as an inter-integrated circuit (I2C) interface, which may be coupled to a microcontroller 920 of the base device 110. Under some embodiments, the first antenna contact 914 and the second antenna contact 918 may be coupled to a radio module of the base device 110.

Under some embodiments, the first antenna contact 914 and the second antenna contact 918 may be located at the back chassis 310 of the base device 110. The smart card 120 may be coupled to the base device 110 such that the side of the smart card 120 having the contact area 126 would face the side of the back chassis 310 having the first antenna contact 914 and the second antenna contact 918. Under this embodiment, the base device 110 may utilize the antenna 220 of the card 110 for wireless communication. Furthermore, under such an embodiment, the antenna 322 of the base device 110 depicted in FIG. 3A may be optional or excluded because the antenna 220 of the card 110 may be sufficient. For example, when the smart card 120 is coupled to the base device 110, the base device 110 and the smart card 120 may form the card system 100 that may communicate with a contactless reader.

Such may be advantageous under embodiments of contactless communication, such as a tap-and-pay interface or the like. Under such embodiments, the user may select via the touch display 112 of the base device 110 an individual card associated with the contactless communication. When the individual card is selected, the card system 100 may perform the contactless communication via the antenna 220 of the card 110. Such contactless communication may occur when the card system 100 is located proximate or within twenty centimeters to a contactless card reader, or by tapping the card system 100 against a payment terminal. Under this embodiment, the reader interface contacts of the contact area 126 may provide an electric path to the antenna 220 of the card 110. Utilizing the antenna 220 of the card 110 for contactless communication of the card system 100 may be advantageous to distance or separate the antenna 220 from metallic material. For example, it may be advantageous to distance or separate the antenna 220 from the back chassis 310, the inner chassis 320, the PCB 326, or the like of the base device 110. Under some embodiments, the back layer 210 and/or the front layer 250 of the card 110 may comprise a plastic material, a non-electrically-conductive material, or the like, which may enhance the performance or signal strength of the antenna 220.

It is to be understood that the antenna 220 may be an NFC antenna and/or a Bluetooth antenna. Under embodiments in which the antenna 220 may be an NFC antenna, the card system 100 may be utilized for NFC interface modes such as read/write mode, peer-to-peer mode, card emulation mode, or the like. Under embodiments where the antenna 220 may be a Bluetooth antenna, the card system 100 may be utilized as a wireless key for a hotel room, a wireless key for an automobile, and the like.

Under some embodiments, when the smart card 120 is coupled to the base device 110 and the card system 100 is used for contactless communication with a card reader, the deployment of the smart card 120 with information about an individual card is optional because the contactless communication may be with the base device 110 via the antenna 220 of the smart card 120, and the smart card 120 may remain coupled with the base device 110 during the contactless communications. This may be advantageous because it may reduce the need for a user to decouple the smart card 120 from the device 100 for transactions such as contactless payments, building access, or the like. It also may be advantageous to increase the security of the card system 100 by requiring that the smart card 120 be coupled to the base device 110 in order to conduct contactless communications or transactions with the card system 100.

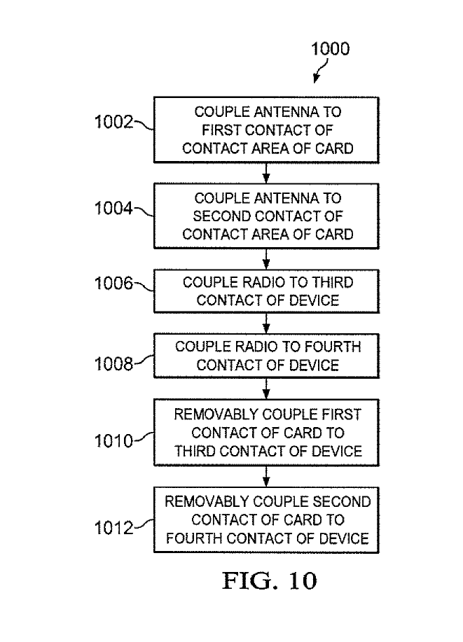

FIG. 10 is a flowchart illustrating a method 1000 of assembling a card system 100, in accordance with embodiments of the present disclosure. At step 1002, the antenna 220 is coupled to the first auxiliary contact 804 of the smart card 120. For example, the first auxiliary contact 804 may be designated C4 under the EMV standard, and the first auxiliary contact 804 may be electrically coupled to the antenna 220. At step 1004, the antenna 220 is coupled to the second auxiliary contact 808 of the smart card 120. For example, the second auxiliary contact 808 may be designated C8 under the EMV standard, and the first auxiliary contact 808 may be electrically coupled to the antenna 220. Such coupling of the antenna 220 to the auxiliary contacts 804,808 may be beneficial because additional contacts outside the contact area 126 may be unnecessary. At step 1006, a radio module, such as a radio module comprising the antenna controller module 924, may be coupled or electrically coupled to the first antenna contact 914 of the base device 110. At step 1008, the radio module may be coupled or electrically coupled to the second antenna contact 918 of the base device 110.

At step 1010, the first auxiliary contact 804 may be removably coupled to the first antenna contact 914. At step 1012, the second auxiliary contact 808 may be removably coupled to the second antenna contact 918. Under some embodiments, the coupling of steps 1010 and 1012 may be via the coupling of the smart card 120 to the base device 110, such as by bringing the smart card 120 into contact with the coupling component 114 of the base device 110. Under this embodiment, the coupling of the smart card 120 to the base device 110 may bring the first auxiliary contact 804 into contact with the first antenna contact 914 and may bring the second auxiliary contact 808 into contact with the second antenna contact 918. Under this embodiment, the uncoupling or removal of the smart card 120 from the base device 110 may separate the first auxiliary contact 804 from the first antenna contact 914 and may separate the second auxiliary contact 808 from the second antenna contact 918.

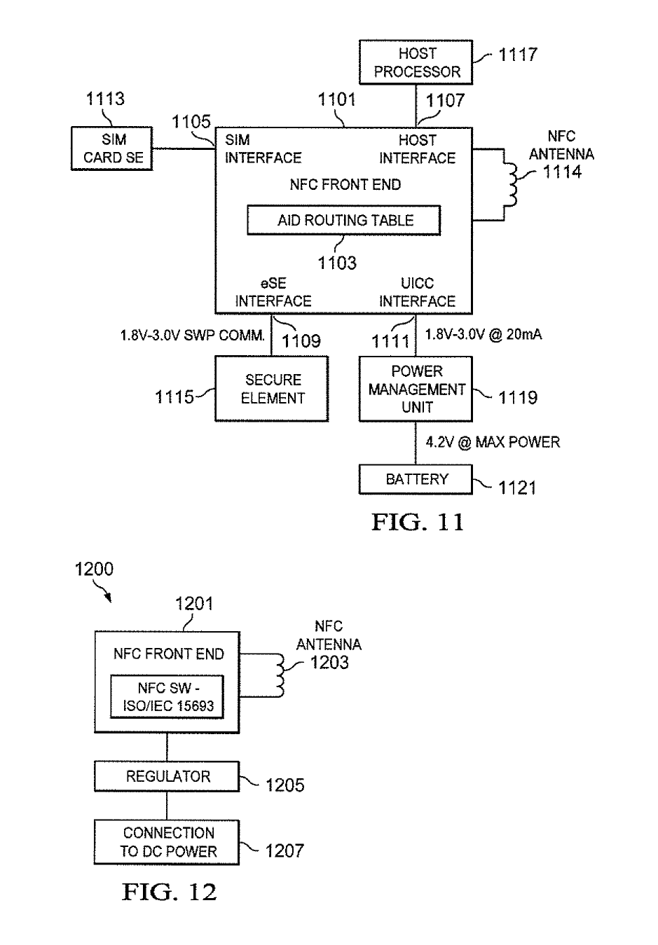

FIG. 11 is block diagram of an NFC device 1101 according to an embodiment of the present disclosure that is configured to function in a smart card. As shown in FIG. 11, the NFC device 1101 comprises an NFC front end IC that includes an AID routing table 1103, a plurality of interfaces 1105, 1107, 1109, 1111, and an NFC antenna 1113. The AID routing table 1103 comprises a list of routing rules, where each routing rule contains an AID and a destination. The destination is associated with one of the plurality of interfaces 1105, 1107, 1109, 1111, and allows the NFC device 1101 to transmit along a path associated with a particular interface to a component or element coupled to the path.

In embodiments, the NFC device 1101 may operate according to a contact or short-range contactless communication interface permitting a physical separation of, e.g., 10 cm or less. In the embodiment shown in FIG. 11, the NFC device has four interfaces 1105, 1107, 1109, 1111, including a Subscriber Identity Module (SIM) Interface 1105, a Host Interface 1107, an Embedded Secure Element (eSE) Interface 1109, and a Universal Integrated Circuit Card (UICC) Interface 1111. The SIM Interface 1105 is coupled to a SIM Card Secure Element (SE) 1113, the eSE Interface 1109 is coupled to a SE 1115, the Host Interface 1107 is coupled to a Host Processor 1117, and the UICC Interface 1111 is coupled to a power management unit 1119, which is coupled to a battery device 1121. In embodiments, the battery device 1121 may comprise any battery that is appropriately sized and configured to operate in the confines of the environment of a smart card. Such a battery may include an appropriately sized chemical battery or a capacitor. While the UICC interface 1111 is coupled to the power management unit 1119 as shown in FIG. 11, in other embodiments, the power management unit may be coupled to a different interface of the NFC device 1101 as appropriate. Furthermore, additional power management units may be coupled to an interface that is otherwise not in use or may be connected in series or parallel with a path of an element coupled to the interface. Corresponding batteries may also be included.

The NFC device 1101 is configured to collect energy from an NFC RF field transmitted by an NFC RF transmitter, such as the transmitter 1200 shown in FIG. 12. The NFC transmitter 1200 comprises an NFC device 1201, such as an NFC front end IC, an NFC antenna 1203, a regulator 1205, and a connection to a power source 1207, such as a DC power source. In the embodiment shown in FIG. 12, the NFC device 1201 is configured to use ISO/IEC protocol 15693. Other protocols associated with NFC, such as ISO/TEC 14443, may be used as well. The NFC device 1101 is configured to route energy collected from an NFC field emitted by the NFC transmitter 1200 to the power management unit and the power management unit 1119 is configured to use the collected energy to charge the battery device 1121.

In the embodiment of FIG. 11, the power management unit 1119 is designed to utilize a maximum voltage of 4.2V and a connection from the UICC interface 1111 to the power management unit 1119 is designed to operate at a voltage of between 1.8V-3.0V with a current of 20 mA. Similarly, the connection between the eSE interface 1109 and the SE 1113 may operate at a voltage of between 1.8V-3.0V according to a Single Wire Protocol (SWP). In an embodiment, the SIM interface 1105 may be connected to a SIM Card SE 1113, however, the SIM Card SE functionality may not be used. In certain embodiments, the Host Processor 1117 may comprise any or all of the structural and functional aspects of a processor or microprocessor, as described herein as appropriate. The battery device 1121 may have a maximum capacity of 160 mAh at a maximum voltage of 4.2V.

In embodiments, the AID routing table 1103 may be programmed to cause the NFC device 1101 to route collected energy from the NFC RF field to the power management unit 1119, which then routes the energy to battery device 1121. This may be accomplished via a charging circuit (not shown) that is either part of the power management unit 1119 or independent thereof.

Further, in one embodiment, the NFC device 1101 may be configured to route the collected energy from the NFC field by routing a request for an unsupported communication protocol to at least one interface of the NFC device 1101. In one embodiment, the unsupported communication protocol may be ISO/TEC 15693. The NFC device 1101 may also be configured such that, upon receiving a request for the unsupported communication protocol, the NFC device 1101 routes the collected energy to the at least one interface and enters a wait mode, where the wait mode comprises the NFC device 1101 waiting for feedback from an NFC transmitter. The NFC device 1101 may remain in the wait mode until the NFC device 1101 is removed from the NFC field. In another embodiment, the NFC device 1101 may be configured to keep a communication link between the NFC device 1101 and an NFC transmitter active even if no further information is being exchanged via the communication link such that charging is accomplished without the exchange of information from a SE.

In another embodiment, the NFC device 1101 is configured to collect energy from the NFC field by waiting for a predetermined period of time, determining if power is present at an interface of the NFC device 1101 after the predetermined period of time, and, upon determining that power is still present at the interface, enabling charging of the battery device. This allows charging if a protocol is used that is already supported by the system for other applications.

In another embodiment, the NFC device 1101 is configured to route collected energy to the power management unit on a dedicated path and the NFC device 1101 is configured to match up the dedicated path upon receiving a request for communication from an NFC transmitter, and provide power on the dedicated path according to the request. In one embodiment, the dedicated path may be for a secure element and the request may be directed to a particular card type that corresponds to the secure element.

In accordance with embodiments of the invention, examples are provided below:

### Example 1

A smart card comprising: at least one interface; a multiplexor component electrically coupled to at least one interface; a first security circuit electrically coupled to the multiplexor component, wherein the first security circuit is configured to transmit a first signal to the multiplexor component, wherein the first security circuit is configured to be provisioned with first information; and a second security circuit electrically coupled to the multiplexor component, wherein the second security circuit is configured to transmit a second signal to the multiplexor component, wherein the second security circuit is configured to be provisioned with second information, wherein the multiplexor component is configured to select a selected signal from at least one of the first signal and the second signal, wherein the multiplexor component is configured to transmit the selected signal to the at least one interface.

### Example 2

The smart card of any of examples 1-10, further comprising: a third security circuit electrically coupled to the multiplexor component, wherein the third security circuit is configured to transmit a third signal to the multiplexor component, wherein the multiplexor component is further configured to select the selected signal from at least one of the first signal, the second signal, and the third signal.

### Example 3

The smart card of any of examples 1-10, further comprising: a magnetic stripe emulator component electrically coupled to the multiplexor component, wherein the magnetic stripe emulator component is configured to transmit a fourth signal to the multiplexor component, wherein the multiplexor component is further configured to select the selected signal from at least one of the first signal, the second signal, and the fourth signal.

### Example 4

The smart card of any of examples 1-10, further comprising: a control module configured to control a selection of the selected signal by the multiplexor component.

### Example 5

The smart card of any of examples 4-10, wherein the control module is configured to receive control information from a base device configured to couple with the smart card.

### Example 6

The smart card of any of examples 4-10, wherein the control module is configured to receive control information from an external electronic device.

### Example 7

The smart card of any of examples 4-10, further comprising: at least one button, wherein the control module is coupled to the at least one button, wherein the at least one button is configured to communicate control information to the control module upon actuation of the at least one button.

### Example 8

The smart card of any of examples 1-10, wherein the first security circuit and the second security circuit are compliant with a Europay, Mastercard and Visa (EMV) standard.

### Example 9

The smart card of any of examples 1-10, wherein the at least one interface comprises at least a first contact designated for a reset signal, a second contact designated for a clock signal, and a third contact designated for an input/output signal.

### Example 10

The smart card of any of examples 1-10, wherein the first security circuit is configured to be provisioned with the first information via a first entity, wherein the second security circuit is configured to be provisioned with the second information via a second entity, wherein the first entity is different from the second entity.

### Example 11

A method comprising: provisioning a first security circuit with first information, wherein the first security circuit is configured to transmit a first signal; provisioning a second security circuit with second information, wherein the second security circuit is configured to transmit a second signal; providing a smart card with the first security circuit and the second security circuit, wherein the first security circuit is communicatively coupled to a multiplexor component of the smart card, wherein the second security circuit is communicatively coupled to the multiplexor component, wherein the multiplexor component is communicatively coupled to at least one interface of the smart card, wherein the multiplexor component is configured to select a selected signal from at least one of the first signal and the second signal, wherein the multiplexor component is configured to transmit the selected signal to the at least one interface.

### Example 12

The method of any of examples 11-20, further comprising: provisioning a third security circuit with third information, wherein the third security circuit is configured to transmit a third signal; and providing the smart card with the third security circuit, wherein the third security circuit is communicatively coupled to the multiplexor component, wherein the multiplexor component is further configured to select the selected signal from at least one of the first signal, the second signal, and the third signal.

### Example 13

The method of any of examples 11-20, further comprising: providing the smart card with a magnetic stripe emulator component, wherein the magnetic stripe emulator component is configured to transmit a fourth signal, wherein the magnetic stripe emulator component is communicatively coupled to the multiplexor component, wherein the multiplexor component is further configured to select the selected signal from at least one of the first signal, the second signal, and the fourth signal.

### Example 14

The method of any of examples 11-20, further comprising: controlling a selection of the selected signal by the multiplexor component.

### Example 15

The method of any of examples 14-20, wherein controlling the selection of the selected signal comprises receiving control information from a device configured to couple with the smart card.

### Example 16

The method of any of examples 14-20, wherein controlling the selection of the selected signal comprises receiving control information from a smart phone or electronic device.

### Example 17

The method of any of examples 14-20, wherein controlling the selection of the selected signal comprises receiving control information based on actuation of at least one button of the smart card.

### Example 18

The method of any of examples 11-20, wherein the first security circuit and the second security circuit are compliant with an EMV standard.

### Example 19

The method of any of examples 11-20, wherein the at least one interface comprises at least a first contact designated for a reset signal, a second contact designated for a clock signal, and a third contact designated for an input/output signal.

### Example 20

The method of any of examples 11-20, wherein provisioning the first security circuit with the first information comprises provisioning the first security circuit with the first information via a first entity, wherein provisioning the second security circuit with the second information comprises provisioning the second security circuit with the second information via a second entity, wherein the first entity is different from the second entity.

While the present disclosure has been described in terms of particular embodiments and illustrative figures, those of ordinary skill in the art will recognize that the present disclosure is not limited to the embodiments or figures described. For example, although the illustrated embodiment of the base device 110 is illustrated as a stand-alone device, the base device 110 may be integrated with other computing devices, such as a smart phone, a tablet computer, or the like.

Although various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and, consequently, are not described in detail herein. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A smart card comprising:
at least one interface;
a multiplexor component electrically coupled to at least one interface;
a first security circuit electrically coupled to the multiplexor component, wherein the first security circuit is configured to transmit a first signal to the multiplexor component, wherein the first security circuit is configured to be provisioned with first information; and
a second security circuit electrically coupled to the multiplexor component, wherein the second security circuit is configured to transmit a second signal to the multiplexor component, wherein the second security circuit is configured to be provisioned with second information, wherein the multiplexor component is configured to select a selected signal from at least one of the first signal and the second signal, wherein the multiplexor component is configured to transmit the selected signal to the at least one interface.

2. The smart card of claim 1, further comprising:
a third security circuit electrically coupled to the multiplexor component, wherein the third security circuit is configured to transmit a third signal to the multiplexor component, wherein the multiplexor component is further configured to select the selected signal from at least one of the first signal, the second signal, and the third signal.

3. The smart card of claim 1, further comprising:
a magnetic stripe emulator component electrically coupled to the multiplexor component, wherein the magnetic stripe emulator component is configured to transmit a fourth signal to the multiplexor component, wherein the multiplexor component is further configured to select the selected signal from at least one of the first signal, the second signal, and the fourth signal.

4. The smart card of claim 1, further comprising:
a control module configured to control a selection of the selected signal by the multiplexor component.

5. The smart card of claim 4, wherein the control module is configured to receive control information from a base device configured to couple with the smart card.

6. The smart card of claim 4, wherein the control module is configured to receive control information from an external electronic device.

7. The smart card of claim 4, further comprising:
at least one button, wherein the control module is coupled to the at least one button, wherein the at least one button is configured to communicate control information to the control module upon actuation of the at least one button.

8. The smart card of claim 1, wherein the first security circuit and the second security circuit are compliant with a Europay, Mastercard and Visa (EMV) standard.

9. The smart card of claim 1, wherein the at least one interface comprises at least a first contact designated for a reset signal, a second contact designated for a clock signal, and a third contact designated for an input/output signal.

10. The smart card of claim 1, wherein the first security circuit is configured to be provisioned with the first information via a first entity, wherein the second security circuit is configured to be provisioned with the second information via a second entity, wherein the first entity is different from the second entity.

11. A method comprising:
provisioning a first security circuit with first information, wherein the first security circuit is configured to transmit a first signal;
provisioning a second security circuit with second information, wherein the second security circuit is configured to transmit a second signal;
providing a smart card with the first security circuit and the second security circuit, wherein the first security circuit is communicatively coupled to a multiplexor component of the smart card, wherein the second security circuit is communicatively coupled to the multiplexor component, wherein the multiplexor component is communicatively coupled to at least one interface of the smart card, wherein the multiplexor component is configured to select a selected signal from at least one of the first signal and the second signal, wherein the multiplexor component is configured to transmit the selected signal to the at least one interface.

12. The method of claim 11, further comprising:
provisioning a third security circuit with third information, wherein the third security circuit is configured to transmit a third signal; and
providing the smart card with the third security circuit, wherein the third security circuit is communicatively coupled to the multiplexor component, wherein the multiplexor component is further configured to select the selected signal from at least one of the first signal, the second signal, and the third signal.

13. The method of claim 11, further comprising:
providing the smart card with a magnetic stripe emulator component, wherein the magnetic stripe emulator component is configured to transmit a fourth signal, wherein the magnetic stripe emulator component is communicatively coupled to the multiplexor component, wherein the multiplexor component is further configured to select the selected signal from at least one of the first signal, the second signal, and the fourth signal.

14. The method of claim 11, further comprising:
controlling a selection of the selected signal by the multiplexor component.

15. The method of claim 14, wherein controlling the selection of the selected signal comprises receiving control information from a device configured to couple with the smart card.

16. The method of claim 14, wherein controlling the selection of the selected signal comprises receiving control information from a smart phone or electronic device.

17. The method of claim 14, wherein controlling the selection of the selected signal comprises receiving control information based on actuation of at least one button of the smart card.

18. The method of claim 11, wherein the first security circuit and the second security circuit are compliant with an EMV standard.

19. The method of claim 11, wherein the at least one interface comprises at least a first contact designated for a reset signal, a second contact designated for a clock signal, and a third contact designated for an input/output signal.

20. The method of claim 11, wherein provisioning the first security circuit with the first information comprises provisioning the first security circuit with the first information via a first entity, wherein provisioning the second security circuit with the second information comprises provisioning the second security circuit with the second information via a second entity, wherein the first entity is different from the second entity.
